(19) United States
(12) Patent Application Publication
(10) Pub. No.: US 2012/0072685 A1
(43) Pub. Date: Mar. 22, 2012

(54) METHOD AND APPARATUS FOR BACKUP OF VIRTUAL MACHINE DATA

(75) Inventor: Toshio OTANI, Sunnyvale, CA (US)

(73) Assignee: HITACHI, LTD., Tokyo (JP)

(21) Appl. No.: 12/883,339

(22) Filed: Sep. 16, 2010

(51) Int. Cl. G06F 12/16; G06F 9/455

(52) U.S. Cl. 711/162; 718/1; 711/E12.103

(57) ABSTRACT

Embodiments of the invention provide backup of virtual machine data and preferably simplify the backup system, especially in the virtual machine environment that uses an external storage subsystem. A system includes a storage system coupled via a network to a server and a management server. The storage system includes a plurality of storage volumes. The server includes virtual machines running thereon and has virtual machine data stored on the storage volumes. The management server comprises a processor, a memory, and a backup control module, which is configured to detect a virtual machine on the server which is suspended or terminated; identify one or more storage volumes which are used by the detected virtual machine; and direct the storage system to create a backup volume of the determined one or more storage volumes to back up data of the identified one or more storage volumes.

### BACKGROUND OF THE INVENTION

The present invention relates generally to data backup in storage systems and, more particularly, to the backup of virtual machine data. In specific embodiments, a backup system for a virtual machine environment uses an external storage subsystem, especially network storage such as SAN (Storage Area Network) and NAS (Network Attached Storage), and a backup method uses external storage subsystem features such as copy, snapshot, and so on.

There are several methods to create backup for virtual machine data by using an external storage subsystem. The first one uses volume (logical unit: LU) based copy/snapshot technology, the second one uses file based copy/snapshot technology, and the third one uses LBA based copy/snapshot technology.

The problem of the first method is that it restricts the configuration of the virtual machine environment when the system administrator wants to create VM (Virtual Machine) based backup. In the VM environment, each VM image data (e.g., VHD, VMFS file) can be stored in a single SAN volume by using file system feature on a virtual machine hypervisor program such as VMware, Hyper-V, Xen, and the like. In such a case, the volume based backup technology does not allow one to create VM based backup because each single volume has multiple VM image data. Examples of LU based backup include Hitachi ShadowImage and QuickShadow.

The second method solves the problem of first method. Under this approach, the storage subsystem provides file system feature via a network such as NFS (Network File System). The virtual machine hypervisor program sees NFS volume, and manages each file as VM image data (e.g., VHD, VMFS file). A NFS supported storage subsystem has features of copy/snapshot for each file which is VM image data. It allows VM based backup by using storage subsystem features. However, file based network storage (NAS) does not provide enough performance as compared to SAN. An example of NFS file based backup is NetApp snapshot.

The third method solves the problem of the first and second methods. Under the third method, the virtual machine hypervisor program enables the storage of multiple VM image data (e.g., VHD, VMFS file) on a single SAN volume in the storage subsystem. In order to create VM base backup, the virtual machine hypervisor program sends LBA address information to the storage subsystem where copy/snapshot features in the storage subsystem should create copy/snapshot. The virtual machine hypervisor program knows which VM consists of which LBAs. However, this method requires very tight integration between the virtual machine hypervisor program and the storage subsystem. The third method involves proprietary technology which is supported by both the virtual machine hypervisor program and the storage subsystem, so that it restricts the system configuration. An example of LBA based backup is VMware vStorage API for Array Integration.

### BRIEF SUMMARY OF THE INVENTION

Exemplary embodiments of the invention provide backup of virtual machine (VM) data. This invention is used to simplify the backup system, especially in the virtual machine environment that uses an external storage subsystem such as SAN.

In one embodiment, a system for backup of VM data includes a storage subsystem, a server, a network, and a management server. The storage subsystem has the capability to serve raw volume access (logical unit) to the server via the network such as SAN. The server includes a virtual machine management system that runs one or more virtual machines on the server, and stores each VM image data on raw volume in the storage subsystem. The storage subsystem creates backup volume of the raw volume which has one or more VM image data by using volume copy/snapshot feature owned by the storage subsystem itself. The storage subsystem may execute backup procedure when the storage subsystem and/or the management server detects VM suspension and/or termination. The management server manages each VM status of each of the backup volume generations. The VM status includes VM identifier, backup generation number, and each VM status such as suspended, killed, running when backup volume was created. The management server restores each restorable VM image by referring to the VM status.

In another embodiment, a system for backup of VM data includes a storage subsystem, a server, a network, and a management server. The storage subsystem has the capability to serve raw volume access (logical unit) to the server via the network such as SAN. The server includes a virtual machine management system that runs one or more virtual machines on the server, and stores each VM image data on raw volume in the storage subsystem. The storage subsystem also provides other raw volumes to one or more virtual machines for other data storing usage. The storage subsystem creates backup volume of the raw volume which has one or more VM image data by using volume copy/snapshot feature owned by the storage subsystem itself. The storage subsystem may execute backup procedure when the storage subsystem and/or the management server detects VM suspension and/or termination. At the same time, the storage subsystem also creates backup volume of the raw volume which the suspended and/or terminated VM uses. The management server manages each VM status of each of the backup volume generations. The VM status includes VM identifier, backup generation number, raw volume identifier, and each VM status such as suspended, killed, running when backup volume was created. The management server restores each restorable VM image and required raw volume by referring to the VM status.

An aspect of the present invention is directed to a system including a storage system coupled via a network to a server and a management server. The storage system includes a plurality of storage volumes. The server includes a plurality of virtual machines running thereon and has virtual machine data stored on the storage volumes. The management server comprises a processor, a memory, and a backup control module. The backup control module is configured to detect a virtual machine on the server which is suspended or terminated; identify one or more storage volumes which are used by the detected virtual machine; and direct the storage system to create a backup volume of the determined one or more storage volumes to back up data of the identified one or more storage volumes.

In some embodiments, for a suspended or terminated virtual machine with the one or more storage volumes used thereby having the backup volume created by the storage system, the suspended or terminated virtual machine is backed up with consistent data. Backup of the virtual machine data has occurred for a plurality of generations of backup. The backup control module is configured to update a virtual machine status management table stored in the memory. The virtual machine status management table includes virtual machine status for the virtual machines with respect to the plurality of generations of backup, and indicates which generation of backup has consistent data of which virtual machine. A virtual machine which is backed up with consistent data for a particular generation of backup is restorable from the particular generation.

In specific embodiments, the backup control module is configured to restore restorable virtual machine data by referring to the virtual machine status management table. In response to a request to restore virtual machine data of a particular virtual machine, the backup control module is configured to: identify one or more backup volumes utilized for backup of one or more volumes used by the particular virtual machine by referring to the virtual machine status management table; create one or more target restore volumes for restoring the virtual machine data of the particular virtual machine; copy oldest virtual machine data of the identified one or more backup volumes to the one or more target restore volumes; and continue copying virtual machine data of the one or more backup volumes to the one or more target restore volumes, for each newer generation of backup until there is no newer generation.

In some embodiments, at least one virtual machine has same virtual machine data stored in at least two volumes in the storage system, the at least two volumes storing the same virtual machine data for a particular virtual machine belonging to a consistency group for the particular virtual machine. The virtual machine status management table includes consistency group information for the at least one virtual machine. The backup control module is configured to refer to the consistency group information in the virtual machine status management table to know which volumes in the storage system belong to a consistency group for which virtual machine and are backed up simultaneously during backup of the virtual machine data, and which backup volumes can be used for restoration of the virtual machine data.

In specific embodiments, at least one virtual machine has same virtual machine data stored in at least two volumes in the storage system, the at least two volumes storing the same virtual machine data for a particular virtual machine belonging to a consistency group for the particular virtual machine. The backup control module is configured to refer to a consistency group management table listing consistency groups of volumes, to know which volumes in the storage system belong to a consistency group for which virtual machine and should be backed up simultaneously during backup of the virtual machine data. The backup control module is configured to determine whether to create backup to other media and, if yes, read data from the backup volume and write the data to the other media. A virtual machine on the server is suspended or terminated when it is detected that storage I/O (input/output) between the virtual machine and the storage system is disconnected.

Another aspect of the invention is directed to a backup control method in a system including a storage system coupled via a network to a server and a management server, the storage system including a plurality of storage volumes, the server including a plurality of virtual machines running thereon and having virtual machine data stored on the storage volumes. The backup control method comprises detecting a virtual machine on the server which is suspended or terminated; identifying one or more storage volumes which are used by the detected virtual machine; and directing the storage system to create a backup volume of the determined one or more storage volumes to back up data of the identified one or more storage volumes.

Another aspect of the invention is directed to a computer-readable storage medium storing a plurality of instructions for controlling a data processor to control backup of virtual machine data in a system including a storage system coupled via a network to a server and a management server, the storage system including a plurality of storage volumes, the server including a plurality of virtual machines running thereon and having virtual machine data stored on the storage volumes. The plurality of instructions comprise instructions that cause the data processor to detect a virtual machine on the server which is suspended or terminated; instructions that cause the data processor to identify one or more storage volumes which are used by the detected virtual machine; and instructions that cause the data processor to direct the storage system to create a backup volume of the determined one or more storage volumes to back up data of the identified one or more storage volumes.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration of an information system in which the method and apparatus of the invention may be applied.

FIG. 2 shows an example of the software configuration of the storage subsystem of FIG. 1.

FIG. 3 shows an example of the software configuration of the server of FIG. 1.

FIG. 4 shows an example of the software configuration of the management server of FIG. 1.

FIG. 5 shows an example of the logical system configuration of the information system in FIG. 1.

FIG. 6 shows an example of the VM status management table in FIG. 4.

FIG. 7 shows an example of a flow diagram of the backup process of the backup control in FIG. 4.

FIG. 8 shows an example of a flow diagram of the process for restoring data of the backup control 302-02 in FIG. 4.

FIG. 9 shows an example of the logical system configuration for detecting VM suspension with VHD (Virtual Hard Disk) files in the volume of the storage subsystem.

FIG. 10 shows an example of the logical system configuration for detecting VM suspension with raw devices as volumes of the storage subsystem.

FIG. 11 shows an example of a flow diagram illustrating a backup process by the IO control in response to a LOGOUT message from VM.

FIG. 12 shows an example of the logical system configuration for performing data volume backup.

FIG. 13 shows an example of the consistency group management table.

FIG. 14 shows an example of the VM status management table with consideration of consistency group.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for backup of virtual machine data.

System Configuration

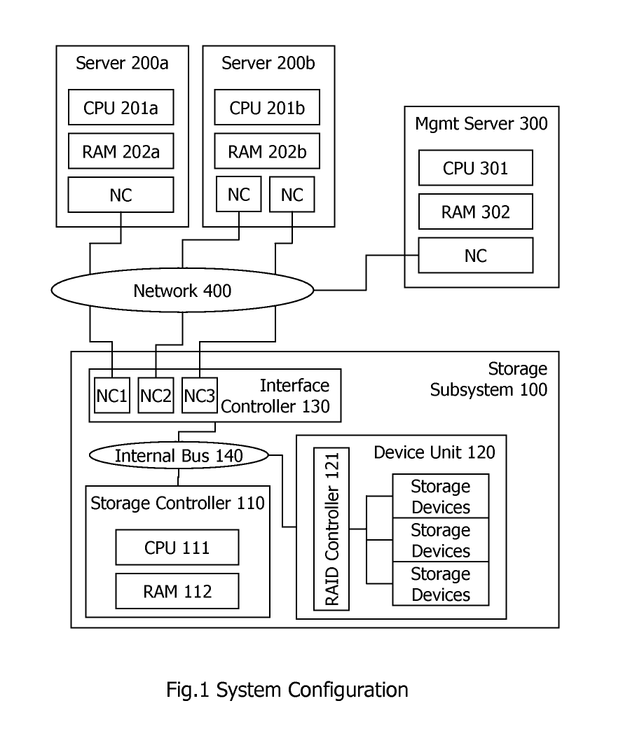

FIG. 1 illustrates an example of a hardware configuration of an information system in which the method and apparatus of the invention may be applied. It includes a storage subsystem 100, one or more servers 200 (200a, 200b), a management server 300, and a network 400. The storage subsystem 100 has the capability of providing storage volume service via SAN (Storage Area Network) to the server 200. The server 200 runs a virtual machine management program which allows the physical server 200 to run one or more virtual machines. One example is VMware, Hyper-V. The management server 300 has the capability to control backup and restore data of each of the components. Every component is connected via the network 400. The network 400 may be Ethernet, Fibre Channel, and so on. The network 400 can be divided into multiple ones such as LAN (Local Area Network) and SAN.

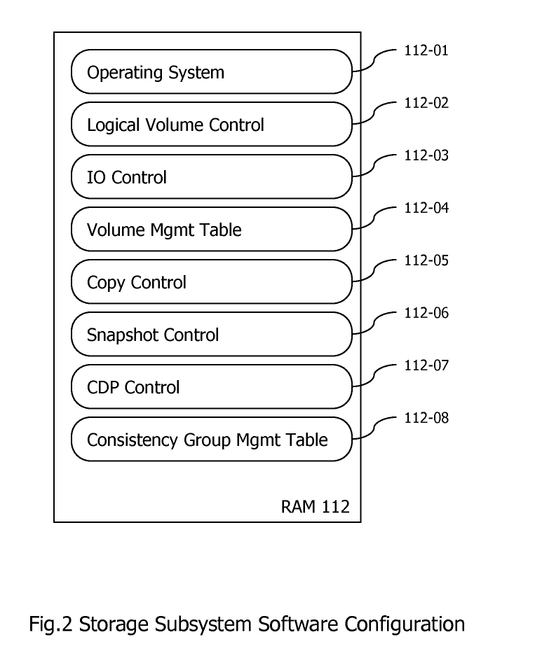

The storage subsystem 100 has a storage controller 110, a device unit 120, an interface controller 130, and an internal bus 140. The storage controller 110 has a CPU 111 and a RAM (Random Access Memory) 112 to store and run software programs as shown in FIG. 2. The device unit 120 has SCSI/RAID (Redundant Array of Inexpensive Disks) controller 121 and storage devices such as HDD (Hard Disk Drive) and/or SSD (Solid State Drive) to store digital data. The interface controller 130 has one or more network controllers (NC) such as Ethernet port and/or Fibre Channel port. One or more storage volumes can be created from RAID protected storage devices and these storage volumes can be exposed by using storage accessing protocol such as Fibre Channel, iSCSI, FCoE (FC over Ethernet), and so on.

FIG. 2 shows an example of the software configuration of the storage subsystem 100 including operating system 112-01. Logical volume control 112-02, 10 control 112-03, and volume management table 112-04 are used to provide storage volume service (FC, iSCSI, FCoE, etc.) to the server 200. Copy control 112-05, snapshot control 112-06, and CDP (Continuous Data Protection) control 112-07 are used to create replication and snapshot of logical volume (not only within storage subsystem 100, but also between multiple storage subsystems). Consistency group management table 112-08 is used to manage logical volume group. If backup operation must take care of data consistency among multiple logical volumes, these logical volumes belong to the same consistency group.

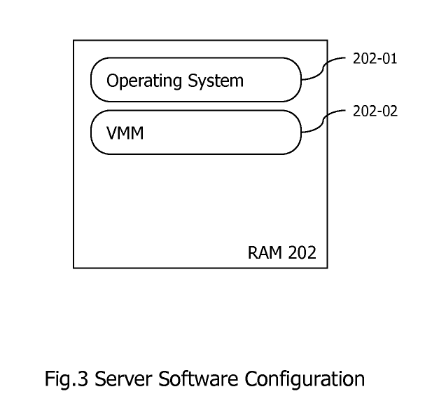

FIG. 3 shows an example of the software configuration of the server 200 including operating system 202-01. VMM 202-02 (Virtual Machine Manager) is referred to as hypervisor program which allows the server 200 to run one or more virtual machines (such as VMware, Hyper-V).

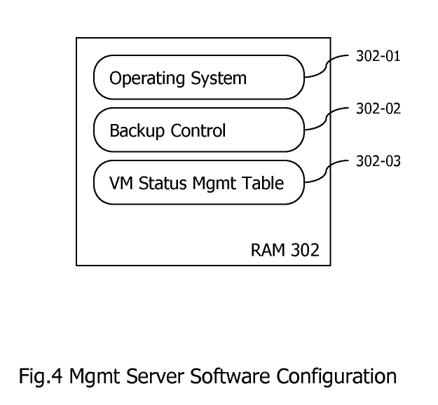

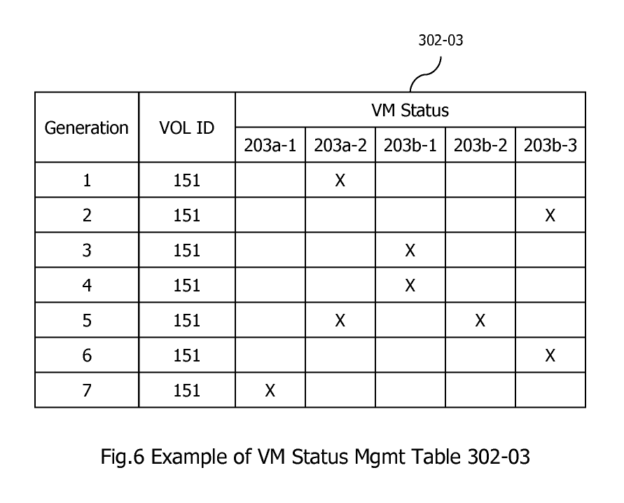

FIG. 4 shows an example of the software configuration of the management server 300 including operating system 302-01. Backup control 302-02 manages virtual machine considerable backup operation with the server 200 and the storage subsystem 100. VM status management table 302-03 manages status of VM backup data. If VM data is backed up when VM is suspended (no I/O, no dirty data on memory, can be restorable), the status will be represented as “X” (see FIG. 6).

VM Backup (VHD)

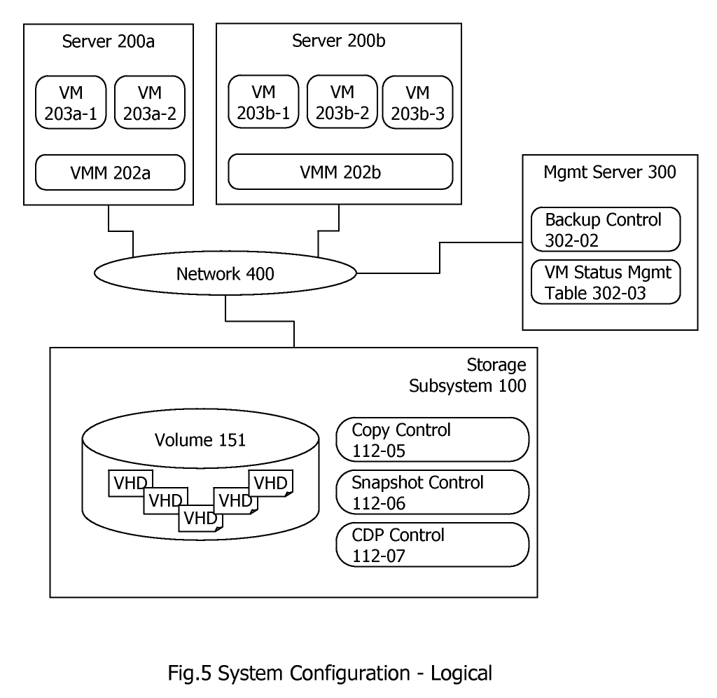

FIG. 5 shows an example of the logical system configuration of the information system in FIG. 1. The storage subsystem 100 provides logical volume 151 to the servers 200a and 200b by using a storage accessing protocol such as FC, iSCSI, FCoE, and so on. The server 200 runs VMM to host virtual machines 203 (including 203a-1 and 203a-2 on the server 200a and 203b-1, 203b-2, 203b-3 on the server 200b). Each VM data is stored in the volume 151. Copy/snapshot/CDP control 112-06/07/08 is used to create backup data of each VM data. The management server 300 controls backup operations using backup control 302-02 and VM status management table 302-03.

The backup control 302-02 directs the storage subsystem 100 to create copy/snapshot/CDP recovery point of volume 151 (hereinafter referred to as backup volume). When a backup volume is created, some VM will be suspended or killed to insure data consistency. If the VM is backed up with data consistency, this VM will be restorable properly.

FIG. 6 shows an example of the VM status management table 302-03 of FIG. 4. It shows that when generation #1 of backup volume was created, VM 203a-2 was suspended, for instance. It also shows that when generation #5 was created, VM 203a-2 and 203b-2 were suspended, for instance. The backup control 302-02 not only directs the storage subsystem 100 to create backup volume, but also directs the server 200 to make specified VM suspend. Alternatively, the backup control 302-02 can direct the storage subsystem 100 to create backup volume when it detects the situation that some VM is already suspended.

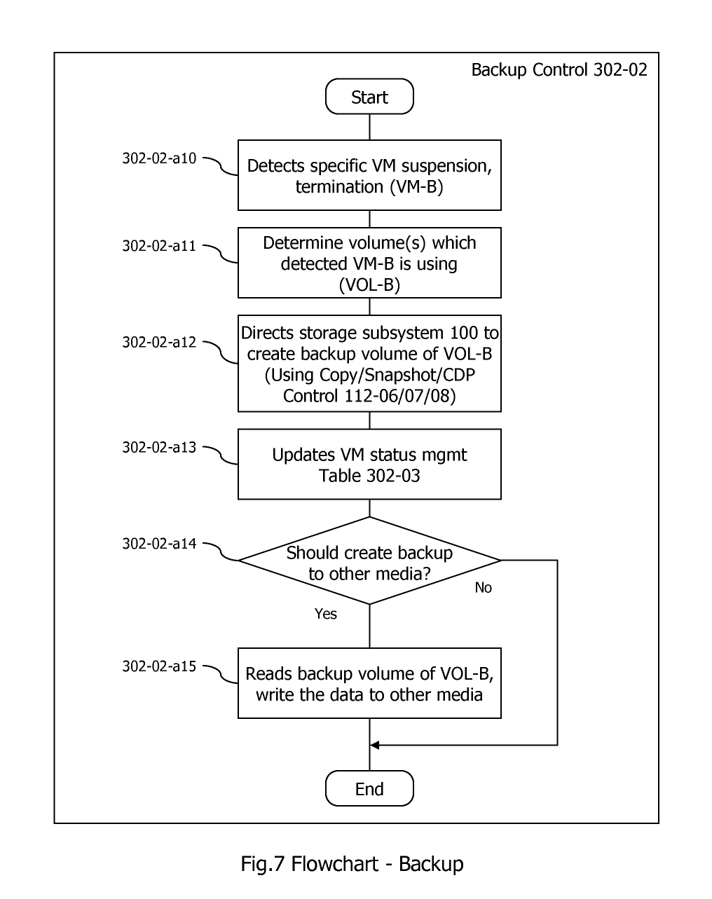

FIG. 7 shows an example of a flow diagram of the backup process of the backup control 302-02 in FIG. 4. In step 302-02-a10, the program detects specific VM suspension or termination (detected VM-B). In step 302-02-a11, the program determines the storage volume(s) used by the detected VM-B (determined VOL-B). In step 302-02-a12, the program directs the storage subsystem 100 to create backup volume of the determined VOL-B, using the copy/snapshot/CDP control 112-06/07/08. In step 302-02-a13, the program updates the VM status management table 302-03. In step 302-02-a14, the program determines whether to create backup to other media. If yes, the program reads the backup volume of VOL-B and writes the data to other media in step 302-02-a15. If no, the process ends.

When the administrator wants to restore the data of a VM, the administrator can refer to the VM status management table 302-03 to know which generation has consistent data of which VM. If the administrator wants to restore the VM 203a-2, for instance, the administrator can use generation #1 and #5 based on the information of the table 302-03 in FIG. 6. Once the administrator creates a replica of the volume 151 using generation #1, the administrator can get consistent VM 203a-2 data from the replicated volume 151. This replicated volume 151 does not have consistent data for other VM such as 203a-1 and 203b-1, 2, 3.

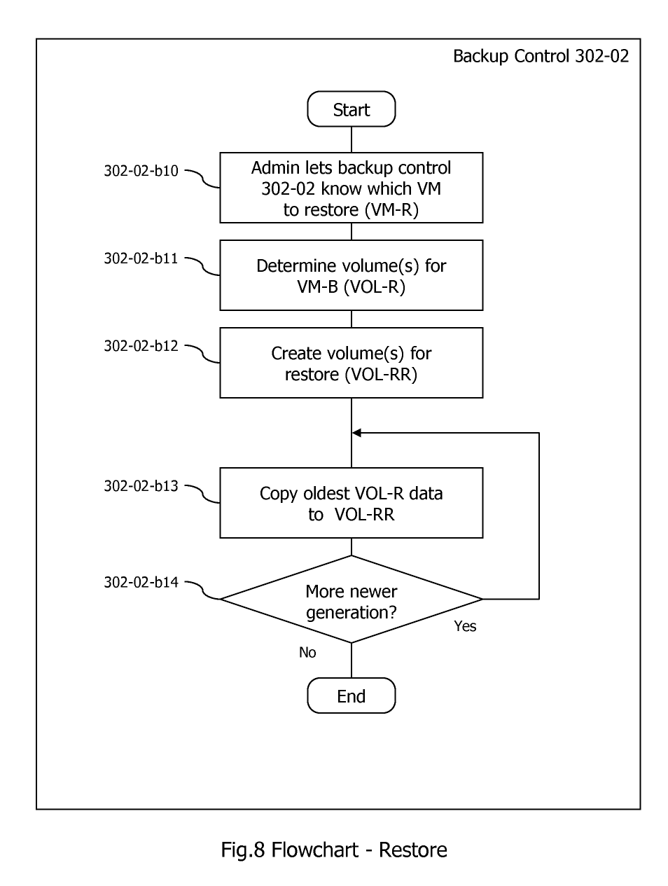

FIG. 8 shows an example of a flow diagram of the process for restoring data of the backup control 302-02 in FIG. 4. In step 302-02-b10, the administrator lets the backup control 302-02 know which VM to restore (VM-R to be restored). In step 302-02-b11, the program determines the backup volume(s) (VOL-R) used for the backup of VM-R. In step 302-02-b12, the program creates the target restore volume(s) (VOL-RR) for restoring VM-R. In step 302-02-b13, the program copies the oldest VOL-R data to VOL-RR. In step 302-02-b14, the program determines whether there is a newer generation. If yes, the program returns to step 302-02-b13. If no, the process ends.

VM Suspension

A suspended VM does not issue storage I/O. Further, it does not leave dirty data in memory, but stores such data in a storage device. Backing up a suspended VM means the data of the VM is restorable.

There are several methods to know which VM is suspended (stopped) or not. One of the popular ways is getting the VM status from the VM management server. Another way is getting the storage I/O status (connected or not). In order to do that, an embodiment of this invention uses the virtual network controller on each VM and storage I/O session data of each VM.

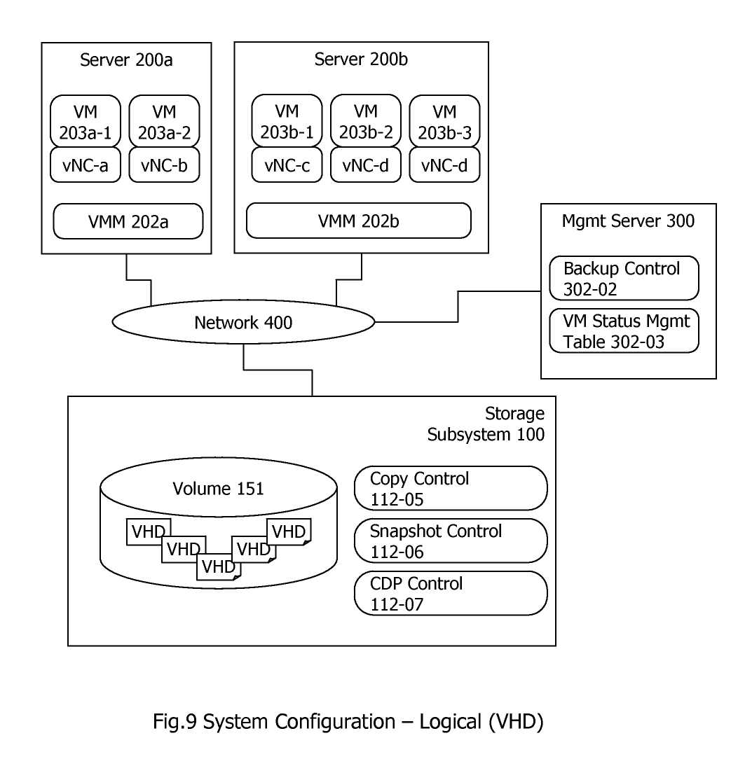

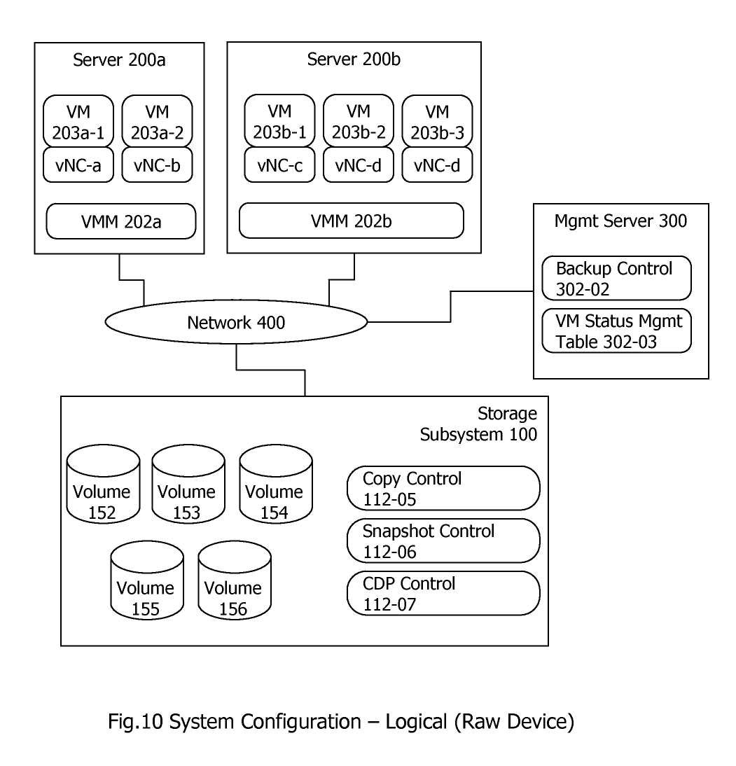

NPIV (N_Port ID Virtualization) allows each VM to have its own WWN (World Wide Name). WWN is used for identification of each virtual network controller. For instance, FIG. 9 and FIG. 10 show examples of the logical system configuration for detecting VM suspension, with VHD (Virtual Hard Disk) files in the volume 151 in FIG. 9 and with raw devices (volumes 152-156) in FIG. 10. VM 203a-1 has vNC-a (virtual network controller), and vNC-a can be identified by using virtual WWN (NPIV). WWN can be used when the server 200a connects to the storage subsystem 100 by using Fibre Channel Protocol or FCoE protocol. When the server 200a disconnects from the storage subsystem 100, the storage subsystem 100 (as well as the management server 300 and network 400) can detect LOGOUT message from the server 200a, which can be identified by the virtual network controller ID (WWN). If the server 200a uses iSCSI, vNC-a will have IP address, MAC address, iSCSI Name as the ID.

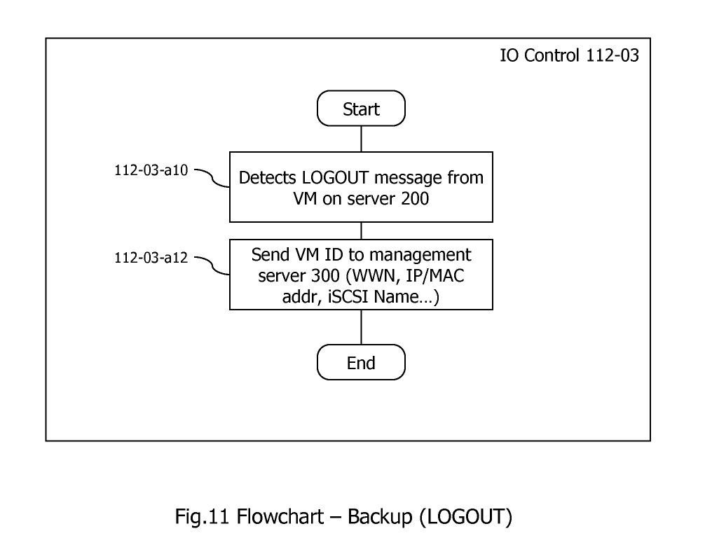

When the storage subsystem 100 (as well as the management server 300 and network 400) detects LOGOUT message from a certain VM, it can be regarded as indicating that the VM is suspended (data is consistent, restorable). The backup control 302-02 knows the status, and starts to create backup of the volume where the data of the VM exists. FIG. 11 shows an example of a flow diagram illustrating a backup process by the IO control 112-03 in response to a LOGOUT message from VM. In step 112-03-a10, the program detects a LOGOUT message from a VM on the server 200. In step 112-03-a12, the program sends the VM ID to the management server 300 (WWN, IP/MAC address, iSCSI Name, etc.). In this way, the storage subsystem 100 knows when the LOGOUT message occurs and when backup volume is to be created, and hence which VM is restorable.

Data Volume Backup

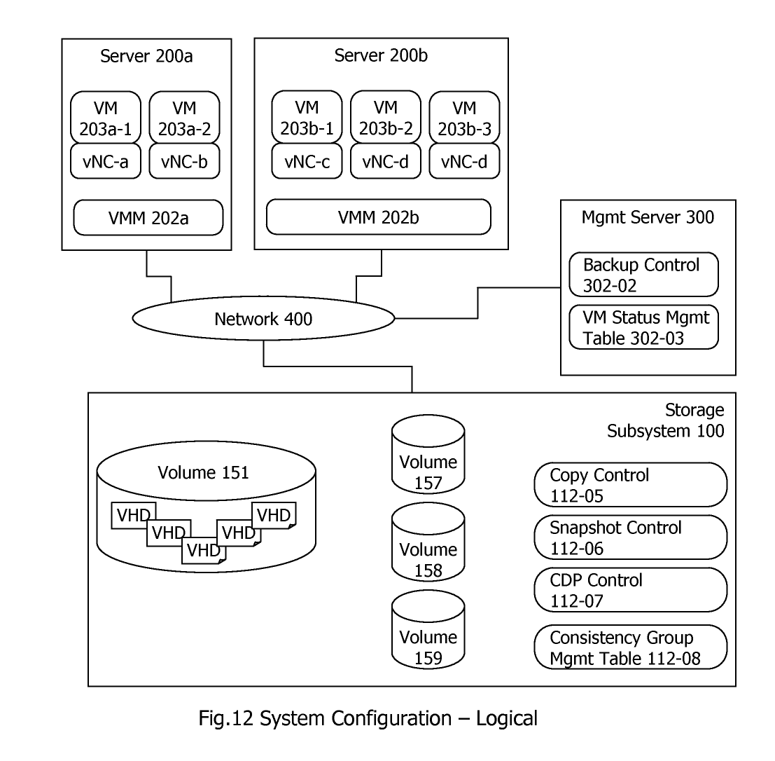

FIG. 12 shows an example of the logical system configuration for performing data volume backup. The storage subsystem 100 has VHD files in the volume 151 and additional volumes 157-159, and the consistency group management table 112-08. In this case, VM 203a-1 also connects to volume 157, VM 203a-2 also connects to volume 158, and VM 203b-1 also connects to volume 159. These VMs would use these other volumes as application data volume (for instance, OS and application program is stored on VHD file in volume 151, but user/application data is stored on volume 157/158/159).

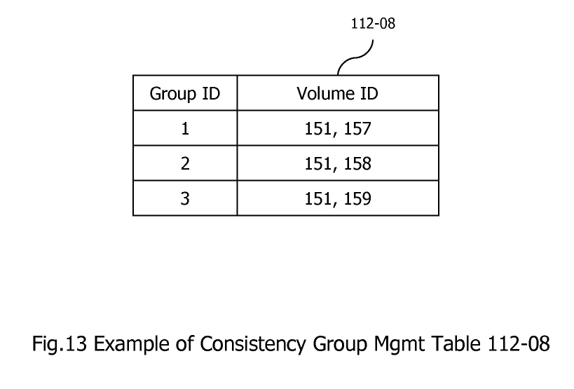

FIG. 13 shows an example of the consistency group management table 112-08 having a group ID column and a volume ID column. As explained above, VM 203a-1 uses volume 151 (containing VHD files) and volume 157, as seen in the first row of the consistency group management table 112-08 (Consistency Group ID 1). When VM 203a-1 is suspended, the backup control 302-02 should create backup data not only in volume 151 but also in volume 157 simultaneously. The backup control 302-02 refers to the consistency group management table 112-08 to know which volumes should be backed up at the same time.

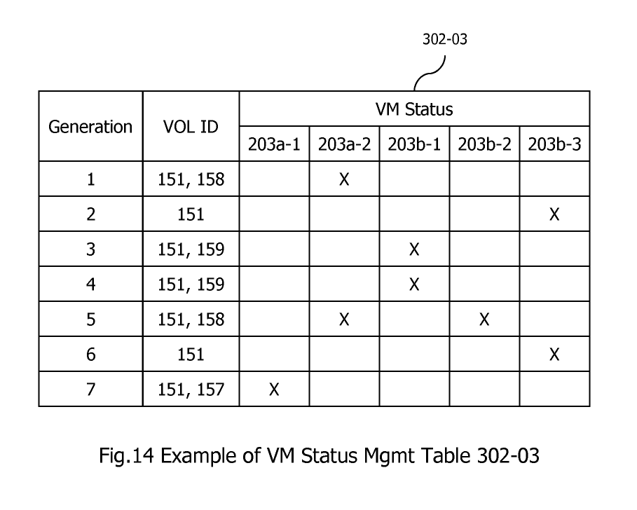

FIG. 14 shows an example of the VM status management table 302-03 with consideration of consistency group. In contrast with FIG. 6, the table in FIG. 14 includes the consistency group data under the VOL ID column (e.g., (151, 158) for generations 1 and 5, (151, 159) for generations 3 and 4, and (151, 157) for generation 7). As such, the management server 300 knows which volumes in the storage system belong to a consistency group for which virtual machine and are backed up simultaneously during backup of the virtual machine data, and which backup volumes can be used for restoration of the virtual machine data.

Of course, the system configurations illustrated in FIGS. 1, 5, 9, 10, and 12 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for backup of virtual machine data. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. In a system including a storage system coupled via a network to a server and a management server, the storage system including a plurality of storage volumes, the server including a plurality of virtual machines running thereon and having virtual machine data stored on the storage volumes, the management server comprising a processor, a memory, and a backup control module, the backup control module being configured to:
detect a virtual machine on the server which is suspended or terminated;
identify one or more storage volumes which are used by the detected virtual machine; and
direct the storage system to create a backup volume of the determined one or more storage volumes to back up data of the identified one or more storage volumes.

2. The management server according to claim 1,
wherein for a suspended or terminated virtual machine with the one or more storage volumes used thereby having the backup volume created by the storage system, the suspended or terminated virtual machine is backed up with consistent data;
wherein backup of the virtual machine data has occurred for a plurality of generations of backup;
wherein the backup control module is configured to update a virtual machine status management table stored in the memory, the virtual machine status management table including virtual machine status for the virtual machines with respect to the plurality of generations of backup, and indicating which generation of backup has consistent data of which virtual machine; and
wherein a virtual machine which is backed up with consistent data for a particular generation of backup is restorable from the particular generation.

3. The management server according to claim 2,
wherein the backup control module is configured to restore restorable virtual machine data by referring to the virtual machine status management table.

4. The management server according to claim 3, wherein in response to a request to restore virtual machine data of a particular virtual machine, the backup control module is configured to:
identify one or more backup volumes utilized for backup of one or more volumes used by the particular virtual machine by referring to the virtual machine status management table;
create one or more target restore volumes for restoring the virtual machine data of the particular virtual machine;
copy oldest virtual machine data of the identified one or more backup volumes to the one or more target restore volumes; and
continue copying virtual machine data of the one or more backup volumes to the one or more target restore volumes, for each newer generation of backup until there is no newer generation.

5. The management server according to claim 2,
wherein at least one virtual machine has same virtual machine data stored in at least two volumes in the storage system, the at least two volumes storing the same virtual machine data for a particular virtual machine belonging to a consistency group for the particular virtual machine;
wherein the virtual machine status management table includes consistency group information for the at least one virtual machine; and
wherein the backup control module is configured to refer to the consistency group information in the virtual machine status management table to know which volumes in the storage system belong to a consistency group for which virtual machine and are backed up simultaneously during backup of the virtual machine data, and which backup volumes can be used for restoration of the virtual machine data.

6. The management server according to claim 1,
wherein at least one virtual machine has same virtual machine data stored in at least two volumes in the storage system, the at least two volumes storing the same virtual machine data for a particular virtual machine belonging to a consistency group for the particular virtual machine;
wherein the backup control module is configured to refer to a consistency group management table listing consistency groups of volumes, to know which volumes in the storage system belong to a consistency group for which virtual machine and should be backed up simultaneously during backup of the virtual machine data.

7. The management server according to claim 1,
wherein the backup control module is configured to determine whether to create backup to other media and, if yes, read data from the backup volume and write the data to the other media.

8. The management server according to claim 1,
wherein a virtual machine on the server is suspended or terminated when it is detected that storage I/O (input/output) between the virtual machine and the storage system is disconnected.

9. A backup control method in a system including a storage system coupled via a network to a server and a management server, the storage system including a plurality of storage volumes, the server including a plurality of virtual machines running thereon and having virtual machine data stored on the storage volumes, the backup control method comprising:
detecting a virtual machine on the server which is suspended or terminated;
identifying one or more storage volumes which are used by the detected virtual machine; and
directing the storage system to create a backup volume of the determined one or more storage volumes to back up data of the identified one or more storage volumes.

10. The backup control method according to claim 9,
wherein for a suspended or terminated virtual machine with the one or more storage volumes used thereby having the backup volume created by the storage system, the suspended or terminated virtual machine is backed up with consistent data;
wherein backup of the virtual machine data has occurred for a plurality of generations of backup;
wherein the backup control method further comprises updating a virtual machine status management table stored in the memory, the virtual machine status management table including virtual machine status for the virtual machines with respect to the plurality of generations of backup, and indicating which generation of backup has consistent data of which virtual machine; and
wherein a virtual machine which is backed up with consistent data for a particular generation of backup is restorable from the particular generation.

11. The backup control method according to claim 10, further comprising:
restoring restorable virtual machine data by referring to the virtual machine status management table.

12. The backup control method according to claim 11, further comprising, in response to a request to restore virtual machine data of a particular virtual machine:
identifying one or more backup volumes utilized for backup of one or more volumes used by the particular virtual machine by referring to the virtual machine status management table;
creating one or more target restore volumes for restoring the virtual machine data of the particular virtual machine;
copying oldest virtual machine data of the identified one or more backup volumes to the one or more target restore volumes; and
continuing copying virtual machine data of the one or more backup volumes to the one or more target restore volumes, for each newer generation of backup until there is no newer generation.

13. The backup control method according to claim 10,
wherein at least one virtual machine has same virtual machine data stored in at least two volumes in the storage system, the at least two volumes storing the same virtual machine data for a particular virtual machine belonging to a consistency group for the particular virtual machine;
wherein the virtual machine status management table includes consistency group information for the at least one virtual machine; and
wherein the backup control method further comprises referring to the consistency group information in the virtual machine status management table to know which volumes in the storage system belong to a consistency group for which virtual machine and are backed up simultaneously during backup of the virtual machine data, and which backup volumes can be used for restoration of the virtual machine data.

14. The backup control method according to claim 9,
wherein at least one virtual machine has same virtual machine data stored in at least two volumes in the storage system, the at least two volumes storing the same virtual machine data for a particular virtual machine belonging to a consistency group for the particular virtual machine;
wherein the backup control method further comprises referring to a consistency group management table listing consistency groups of volumes, to know which volumes in the storage system belong to a consistency group for which virtual machine and should be backed up simultaneously during backup of the virtual machine data.

15. The backup control method according to claim 9, further comprising:
determining whether to create backup to other media and, if yes, read data from the backup volume and write the data to the other media.

16. The backup control method according to claim 9,
wherein a virtual machine on the server is suspended or terminated when it is detected that storage I/O (input/output) between the virtual machine and the storage system is disconnected.

17. A computer-readable storage medium storing a plurality of instructions for controlling a data processor to control backup of virtual machine data in a system including a storage system coupled via a network to a server and a management server, the storage system including a plurality of storage volumes, the server including a plurality of virtual machines running thereon and having virtual machine data stored on the storage volumes, the plurality of instructions comprising:
instructions that cause the data processor to detect a virtual machine on the server which is suspended or terminated;
instructions that cause the data processor to identify one or more storage volumes which are used by the detected virtual machine; and
instructions that cause the data processor to direct the storage system to create a backup volume of the determined one or more storage volumes to back up data of the identified one or more storage volumes.

18. The computer-readable storage medium according to claim 17,
wherein for a suspended or terminated virtual machine with the one or more storage volumes used thereby having the backup volume created by the storage system, the suspended or terminated virtual machine is backed up with consistent data;
wherein backup of the virtual machine data has occurred for a plurality of generations of backup;
wherein the plurality of instructions further comprise instructions that cause the data processor to update a virtual machine status management table, the virtual machine status management table including virtual machine status for the virtual machines with respect to the plurality of generations of backup, and indicating which generation of backup has consistent data of which virtual machine; and
wherein a virtual machine which is backed up with consistent data for a particular generation of backup is restorable from the particular generation.

19. The computer-readable storage medium according to claim 18, wherein the plurality of instructions include instructions to restore virtual machine data of a particular virtual machine which is restorable based on information in the virtual machine status management table, in response to a request to restore the virtual machine data, the instructions comprising:
instructions that cause the data processor to identify one or more backup volumes utilized for backup of one or more volumes used by the particular virtual machine by referring to the virtual machine status management table;
instructions that cause the data processor to create one or more target restore volumes for restoring the virtual machine data of the particular virtual machine;
instructions that cause the data processor to copy oldest virtual machine data of the identified one or more backup volumes to the one or more target restore volumes; and
instructions that cause the data processor to continue copying virtual machine data of the one or more backup volumes to the one or more target restore volumes, for each newer generation of backup until there is no newer generation.

20. The computer-readable storage medium according to claim 18,
wherein at least one virtual machine has same virtual machine data stored in at least two volumes in the storage system, the at least two volumes storing the same virtual machine data for a particular virtual machine belonging to a consistency group for the particular virtual machine;
wherein the virtual machine status management table includes consistency group information for the at least one virtual machine; and
wherein the plurality of instructions further comprise instructions that cause the data processor to refer to the consistency group information in the virtual machine status management table to know which volumes in the storage system belong to a consistency group for which virtual machine and are backed up simultaneously during backup of the virtual machine data, and which backup volumes can be used for restoration of the virtual machine data.
